(19) United States
(12) Patent Application Publication
(10) Pub. No.: US 2023/0267708 A1
(43) Pub. Date: Aug. 24, 2023

(54) METHOD FOR GENERATING A LEARNING MODEL, A PROGRAM, AND AN INFORMATION PROCESSING APPARATUS

(71) Applicant: SONY GROUP CORPORATION, TOKYO (JP)

(72) Inventors: SUGURU AOKI, TOKYO (JP); RYUTA SATOH, TOKYO (JP)

(21) Appl. No.: 18/004,220

(22) PCT Filed: Jun. 30, 2021
(86) PCT No.: PCT/JP2021/024668

§ 371 Date: Jan. 4, 2023

(30) Foreign Application Priority Data
Jul. 14, 2020 (JP) 2020-120705

(51) Int. Cl. G06V 10/774; G06N 3/0464; G06V 10/82; G06V 10/776

(52) U.S. Cl. CPC G06V 10/774; G06N 3/0464; G06V 10/82; G06V 10/776

(57) ABSTRACT

The present technology relates to a method for generating a learning model, a program, and an information processing apparatus that enable image recognition with reduced influence of brightness in a target image.

A learning model is trained such that a total sum of coefficients in one or more channels of at least one or more convolution filters among the convolution filters for a first layer of a neural network including a plurality of the convolution filters approaches zero, the neural network being applied to the learning model that performs recognition processing on input data.

### TECHNICAL FIELD

The present technology relates to a method for generating a learning model, a program, and an information processing apparatus, and more particularly, to a method for generating a learning model, a program, and an information processing apparatus that enable image recognition with reduced influence of brightness in a target image.

### BACKGROUND ART

Patent Document 1 discloses that learning is performed in a learning model including a convolutional neural network structure, by imposing a restriction such that a sum of weights of the same element positions of a plurality of channels of a convolution filter becomes 0.

### CITATION LIST

### Patent Document

Patent Document 1: Japanese Patent Application Laid-Open No. 2019-87021

### SUMMARY OF THE INVENTION

### Problems to be Solved by the Invention

In a case where image recognition of a target image is performed by using a learning model, brightness in the image affects recognition accuracy.

The present technology has been made in view of such a situation, and enables image recognition with reduced influence of brightness in a target image.

### Solutions to Problems

A method for generating a learning model according to a first aspect of the present technology is a method for generating a learning model, the method including training the learning model such that a total sum of coefficients in one or more channels of at least one or more convolution filters among the convolution filters for a first layer of a neural network including a plurality of the convolution filters approaches zero, the neural network being applied to the learning model that performs recognition processing on input data.

A program according to the first aspect of the present technology is a program for causing a computer to function as a processing unit that trains a learning model such that a total sum of coefficients in one or more channels of at least one or more convolution filters among the convolution filters for a first layer of a neural network including a plurality of the convolution filters approaches zero, the neural network being applied to the learning model that performs recognition processing on input data.

In the first aspect of the present technology, a learning model is trained such that a total sum of coefficients in one or more channels of at least one or more convolution filters among the convolution filters for a first layer of a neural network including a plurality of the convolution filters approaches zero, the neural network being applied to the learning model that performs recognition processing on input data.

An information processing apparatus according to a second aspect of the present technology is an information processing apparatus including a processing unit that executes an operation of a learning model trained such that a total sum of coefficients in one or more channels of at least one or more convolution filters among the convolution filters for a first layer of a neural network including a plurality of the convolution filters approaches zero, the neural network being applied to the learning model that performs recognition processing on input data.

In the second aspect of the present technology, there is executed an operation of a learning model trained such that a total sum of coefficients in one or more channels of at least one or more convolution filters among the convolution filters for a first layer of a neural network including a plurality of the convolution filters approaches zero, the neural network being applied to the learning model that performs recognition processing on input data.

### BRIEF DESCRIPTION OF DRAWINGS

FIG. 1 is a block diagram illustrating a configuration example of an image recognition apparatus to which the present technology is applied.

FIG. 2 is a diagram describing action of a pre-processing unit.

FIG. 3 is a diagram describing action of the pre-processing unit.

FIG. 4 is a diagram describing action of a zero-sum convolution filter for a first layer.

FIG. 5 is a diagram describing action of the zero-sum convolution filter for the first layer.

FIG. 6 is a diagram describing action of the zero-sum convolution filter for the first layer.

FIG. 7 is a diagram exemplifying a structure of a CNN in a recognizer.

FIG. 8 is a diagram describing action of a regularization term.

FIG. 9 is a diagram describing action of a regularization term.

FIG. 10 is a flowchart exemplifying a procedure for learning processing of a learning model (CNN) executed by the recognizer.

FIG. 11 is a flowchart exemplifying calculation processing of a regularization term in Step S13 in FIG. 10.

FIG. 12 is a flowchart exemplifying a processing procedure for image recognition processing performed by the image recognition apparatus.

FIG. 13 is a flowchart exemplifying a processing procedure for CNN processing in Step S52 in FIG. 12.

FIG. 14 is a diagram describing action of the CNN in a case where there is a zero-sum convolution filter in a second layer.

FIG. 15 is a diagram describing action of the CNN in a case where there is a zero-sum convolution filter in the second layer.

FIG. 16 is a diagram describing action of the CNN in a case where there is a zero-sum convolution filter in the second layer.

FIG. 17 is a diagram describing action of the CNN in a case where there is a zero-sum convolution filter in the second layer.

FIG. 18 is a block diagram illustrating another configuration example of the image recognition apparatus.

FIG. 19 is a diagram describing a result of a convolution operation performed by a first CNN processing unit in the recognizer by using a zero-sum convolution filter.

FIG. 20 is a diagram describing a result of a convolution operation performed by the first CNN processing unit in the recognizer by using the zero-sum convolution filter.

FIG. 21 is a diagram describing a result of a convolution operation performed by the first CNN processing unit in the recognizer by using the zero-sum convolution filter.

FIG. 22 is a block diagram illustrating a configuration example of hardware of a computer that executes a series of processing with a program.

### MODE FOR CARRYING OUT THE INVENTION

Hereinafter, an embodiment of the present technology will be described with reference to the drawings.

<Embodiment of Image Recognition Apparatus to which Present Technology is Applied>

(Overall Configuration of Image Recognition Apparatus 11)

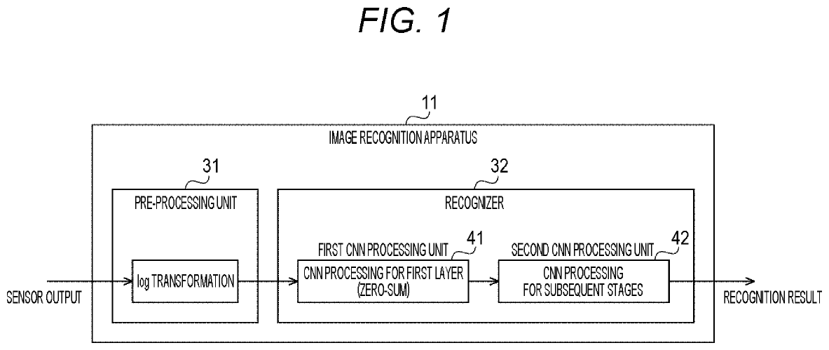

FIG. 1 is a block diagram illustrating a configuration example of an image recognition apparatus to which the present technology is applied.

An image recognition apparatus 11 in FIG. 1 captures sensor data (image data), which is output from an image sensor such as a complementary MOS (CMOS) sensor or a charge-coupled device (CCD) sensor, as an image to be recognized (hereinafter, referred to as a target image), and performs image recognition of the target image. The image recognition apparatus 11 performs, with the image recognition, classification by a subject in the target image, classification and detection of the subject included in the target image, and the like, and outputs a recognition result to an external processing unit or apparatus. In this regard, however, input data to the image recognition apparatus 11 is not limited to sensor data from a sensor.

Although details will be described later, the image recognition apparatus 11 reduces a change in the result of the image recognition even in a case where brightness in the target image changes in a case where global illumination of a shooting environment changes. The image recognition apparatus 11 improves image recognition accuracy in a case where the target image is dark.

The image recognition apparatus 11 sets, as a target image, an image shot by a camera used outdoors, such as a vehicle-mounted camera, a camera mounted on a drone, or a surveillance camera, for example. Images shot by the camera used outdoors have different brightness between daytime and nighttime. In general, image recognition accuracy for an image shot at nighttime is lower than image recognition accuracy for an image shot at daytime. The image recognition apparatus 11 enables obtaining of image recognition accuracy for an image shot at nighttime equivalent to image recognition accuracy obtained for an image shot at daytime.

The image recognition apparatus 11 is not limited to a case where an image shot by the camera used indoors is a target image. The image recognition apparatus 11 may be a case where an image, which is shot indoors by a camera mounted on a mobile terminal such as a smartphone, a camera such as a web camera or digital camera used for a game user interface (UI), or an arbitrary camera, is a target image. The image recognition apparatus 11 enables obtaining stable image recognition accuracy regardless of a change in indoor illumination. The image recognition apparatus 11 may be applied as an image recognition apparatus in a game UI or the like.

The image recognition apparatus 11 may be a case where an image shot by a camera mounted on a handheld camera or on a mobile object is set as a target image. The image recognition apparatus 11 enables obtaining stable image recognition accuracy regardless of a change in an amount of light due to adjustment of shutter speed of the camera. For example, in a case where the shutter speed is shortened for prevention of blurring, it is possible to reduce deterioration in image recognition accuracy even when the shot image is dark.

Note that, when a location or the number of illuminations change, a result of image recognition may change, whereas image recognition accuracy is improved.

The image recognition apparatus 11 includes a pre-processing unit 31 and a recognizer 32 (recognition unit).

The pre-processing unit 31 performs log transformation (logarithmic transformation) on the target image from the image sensor, and supplies the target image to the image recognition apparatus 11. The log transformation is processing of transforming a pixel value x of each pixel of the target image into a pixel value y with the following formula.

y=a×log x+b

where a and b are constants.

The recognizer 32 performs arithmetic processing of a learning model trained with a deep learning method. A convolutional neural network (CNN) is applied to the learning model.

The recognizer 32 performs image recognition on the target image from the pre-processing unit 31 by using the learning model (CNN), and supplies a result thereof to an external processing unit or apparatus. Note that the image recognition in the recognizer 32 may be processing of extracting arbitrary information from the target image, and is not limited to specific processing.

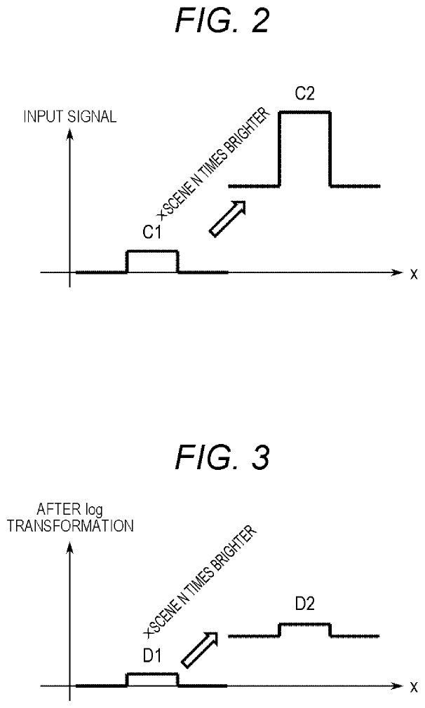

FIGS. 2 and 3 are diagrams describing action of the pre-processing unit 31.

In the graph in FIG. 2, image signals C1, C2 represent image signals of a target image input to the pre-processing unit 31. The image signal C2 exemplifies an image signal of the target image shot in an environment N times brighter than in a case of the image signal C1. According to this, when an environment in which the target image is shot becomes brighter, not only an offset but also amplitude greatly changes corresponding to the brightness of N times.

In the graph in FIG. 3, image signals D1, D2 exemplify image signals obtained by the pre-processing unit 31 performing log transformation on the image signals C1, C2 in FIG. 2, respectively. In the log transformation, a change in brightness N times the shooting environment is transformed from action of making the image signals N times to action of adding a value corresponding to log N. The log transformation also has action of compressing an image signal. Therefore, although an offset changes for the image signal D2 from the image signal D1, a change in amplitude is reduced.

The image recognition apparatus 11 may not include the pre-processing unit 31, and the pre-processing unit 31 may perform transformation other than the log transformation on the target image.

In a case of performing a transformation similar to the log transformation, the pre-processing unit 31 may perform transformation by using a polyline function approximate to a log function. In this case, an amount of calculation is reduced.

The pre-processing unit 31 may perform transformation by using a gamma curve. The pre-processing unit 31 can perform transformation approximate to the log function by using a gamma curve with which I^{2.2} is output for input I. Because transformation using a gamma curve is common for image signal processing, existing techniques and resources can be used.

(Details of Recognizer 32)

As described above, the recognizer 32 performs image recognition with CNN on the target image on which the log transformation has been performed, the target image being from the pre-processing unit 31. In the present embodiment, the CNN includes a plurality of convolution layers.

The recognizer 32 includes a first CNN processing unit 41 and a second CNN processing unit 42.

The first CNN processing unit 41 represents a processing unit that performs, of CNN-based processing (CNN processing), CNN processing on up to a first convolution layer. The second CNN processing unit 42 represents a processing unit that performs CNN processing in a stage subsequent to the first convolution layer.

Note that, as described later, the CNN includes a plurality of sets of a convolution layer and a pooling layer, and there are a convolution layer and a pooling layer alternately. Hereinafter, an n-th layer means the n-th layer among the same kind of layers. Therefore, when counted from an input side, a pooling layer next to the first convolution layer is a first pooling layer, and a convolution layer next to the first pooling layer is a second convolution layer. Although it is assumed that the first CNN processing unit 41 performs processing only on the first convolution layer (convolution operation), the first CNN processing unit 41 may perform processing in up to a previous stage of the second convolution layer (processing on up to the first pooling layer). Hereinafter, a convolution filter used in an n-th convolution layer is also referred to as a convolution filter for an n-th-layer.

The first CNN processing unit 41 performs a convolution operation in the first convolution layer by using a zero-sum convolution filter.

In the present specification, the zero-sum convolution filter refers to a filter trained so that a total sum of weights (coefficients) of the convolution filter (kernel) approaches 0 (zero) (becomes 0), the weights being arranged in a lattice pattern. The total sum of weights of the zero-sum convolution filter is ideally 0, but may not necessarily be 0. Note that, in a case where the convolution filter has a plurality of channels (to be described later), learning is performed such that a total sum of weights of each of the channels approaches 0.

In order to describe action of the zero-sum convolution filter, it is assumed that a convolution filter for the first layer is a one-dimensional filter having three weights as elements. For one, a non-zero-sum convolution filter (−1, 4, −1) is assumed, and for another, a zero-sum convolution filter (−1, 2, −1) is assumed.

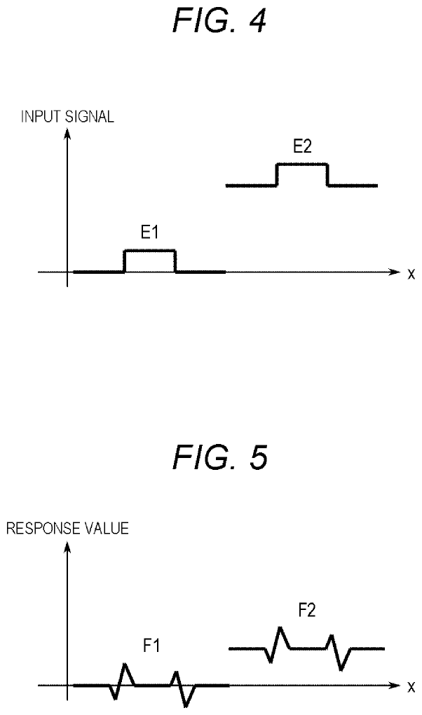

FIGS. 4 to 6 are diagrams describing action of a zero-sum convolution filter for a first layer.

In the graph in FIG. 4, image signals E1, E2 represent image signals of the target image input to the recognizer 32. The image signals E1, E2 correspond to the image signals D1, D2 in FIG. 3, respectively. The image signal E2 is an image signal of the target image shot in an environment brighter than in a case of the image signal E1.

In the graph in FIG. 5, image signals F1, F2 represent response signals in a case where a convolution operation is performed on the image signals E1, E2, respectively by using the non-zero-sum convolution filter (−1, 4, −1). According to this, an offset remains in the image signal F2 with respect to the image signal F1. Therefore, results of convolution operations for the image signal E1 and for the offset image signal E2 are different from each other.

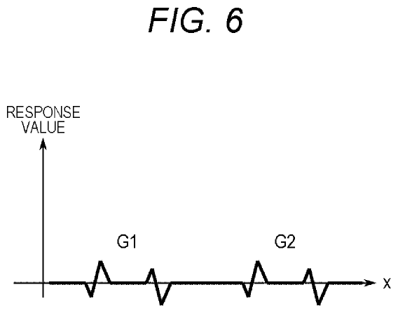

In the graph in FIG. 6, image signals G1, G2 represent response signals in a case where a convolution operation is performed on the image signals E1, E2, respectively by using the zero-sum convolution filter (−1, 2, −1). According to this, the offset of the image signal G2 disappears with respect to the image signal G1. Therefore, results of convolution operations for the image signal E1 and the offset image signal E2 substantially coincide with each other. That is, by using a zero-sum convolution filter as a convolution filter for the first layer, an image for which influence of brightness is reduced from the target image shot in a shooting environment with different brightness (target image having different brightness) is calculated as an image for the first convolution layer (feature map). As a result, influence of brightness in the target image is reduced in image recognition by the recognizer 32.

Patent Document 1 (Japanese Patent Application Laid-Open No. 2019-87021) discloses that, for convolution filters for three channels of red (R), green (G), and blue (B) of a color image, a total sum of weights at the same position is zeroed. However, Patent Document 1 is not a zero-sum convolution filter that zeroes a total sum of weights in each channel of one convolution filter. Patent Document 1 aims to improve learning efficiency. In these respects, Patent Document 1 is different from the recognizer 32 using a zero-sum convolution filter.

In the recognizer 32 in FIG. 1, the second CNN processing unit 42 performs CNN processing in a stage subsequent to the first convolution layer. In the second CNN processing unit 42, convolution using convolution filters for the second and subsequent layers is performed. For the convolution filters for the second and subsequent layers, not limited to filters trained as zero-sum convolution filters, there are used convolution filters trained by a well-known arbitrary method are used. Note that the second and subsequent convolution filters will be described as non-zero-sum convolution filters.

(Description of CNN)

The CNN used as the learning model by the recognizer 32 may have a well-known CNN structure, and is not limited to a CNN having a specific structure.

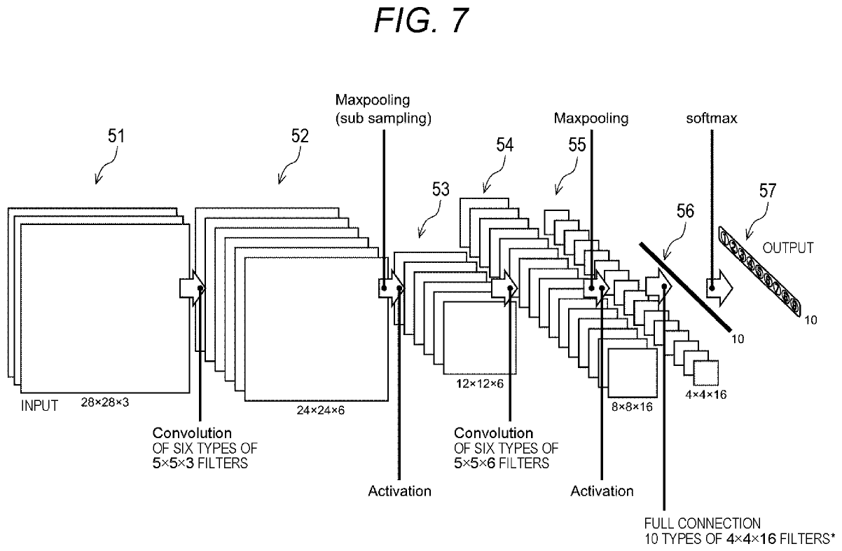

FIG. 7 is a diagram exemplifying a structure of a CNN in the recognizer 32. Note that a size of the target image, sizes of the convolution filters, and the like in FIG. 7 do not necessarily coincide with actual sizes thereof. Furthermore, the structure of the CNN in FIG. 7 is a general CNN structure, and thus will be briefly described.

In FIG. 7, the target image as an input to the recognizer 32 is input to an input layer 51 of the CNN. The target image is, for example, a color image in which one pixel includes pixel values of red (R), green (G), and blue (B) (hereinafter, referred to as RGB). In this regard, however, the target image may be a gray-scale image in which one pixel has a pixel value of only luminance.

The target image has an image size of, for example, 28×28 (width (W)×height (H)), and includes three channels of RGB. When one target image is represented as one volume by combining three channels of RGB, a volume size (W×H×the number of channels) of the target image is 28×28×3.

In a convolution layer 52, a convolution operation using six types of convolution filters is performed to generate images (feature maps) for six channels. The convolution filters, each having a filter size of 5×5 (W×H), are applied for the respective RGB channels of the target images in the input layer 51, and are arranged in a depth direction for three channels. Therefore, the filter size (W×H×the number of channels) of the convolution filters used for the target images is 5×5×3. Note that, because the convolution filters for the first layer are zero-sum convolution filters in the present embodiment, learning is performed such that the total sum of weights of the convolution filters of 5×5 (W×H) for the respective RGB channels approaches 0.

In the convolution operation, pixel values in a window having the same size (5×5×3) as the convolution filters are extracted from the volume of the target images in the input layer 51, each pixel value in the window and each weight of the convolution filter are multiplied by elements at the same position, and then all of them are summed. The summed value is a pixel value of one pixel of an image in the convolution layer 52. Such a convolution operation is performed while shifting, by one pixel each, a position of the window with respect to the target images, and images of 24×24 (W×H) are generated in the convolution layer 52. Note that a shift width is not limited to one pixel.

Because there are six types of convolution filters, images for six channels are generated in the convolution layer 52 by a convolution operation. Therefore, a volume size (W×H×the number of channels) of the images in the convolution layer 52 is 24×24×6. Note that the first CNN processing unit 41 in FIG. 1 performs processing up to generation of the images in the convolution layer 52.

In a pooling layer 53, max pooling and activation processing are performed on the images of 24×24×6 (W×H×the number of channels) generated in the convolution layer 52, and images (feature maps) of 12×12×6 (W×H×the number of channels) are generated.

In the max pooling processing, pixel values in a window of 2×2 (W×H) are extracted for images of respective channels of the convolution layer 52, and a maximum value among the pixel values in the window is set as a pixel value of one pixel. Such processing is performed on an image of each channel while shifting by two pixels each, and an images of 12×12 (W×H) for six channels are generated. Instead of the max pooling, another pooling processing such as average value pooling may be performed.

In the activation processing, pixel values of respective pixels of the images generated by the max pooling are transformed by an activation function such as a ReLu function.

By these max pooling and activation processing, images having a volume size of 12×12×6 (W×H×the number of channels) are generated in the pooling layer 53.

A convolution layer 54 is a second convolution layer with respect to the convolution layer 52 as the first convolution layer. In the convolution layer 54, a convolution operation using 16 types of convolution filters is performed on the images of 12×12×6 (W×H×the number of channels) generated in the pooling layer 53, and images (feature maps) for 16 channels are generated. A filter size (W×H×the number of channels) of the convolution filters is 5×5×6. A convolution operation of the convolution layer 54 is performed similarly to the convolution layer 52, and images of 8×8×16 (W×H×the number of channels) are generated.

A pooling layer 55 is a second pooling layer with the pooling layer 53 as the first layer. In the pooling layer 55, max pooling and activation processing similar to the max pooling and activation processing on the pooling layer 53 are performed on the images of 8×8×16 generated in the convolution layer 54, and images of 4×4×16 (W×H×the number of channels) are generated.

Note that, although a case where two sets of convolution layer and pooling apparatus are provided is exemplified in the CNN in FIG. 7, three or more sets of convolution layer and pooling apparatus may be provided.

In a fully-connected layer 56, pixel values of all the pixels of the images of 4×4×16 (W×H×the number of channels) generated in the pooling layer 55 are input to each of 10 nodes. A weight to be multiplied by an input value and a bias to be added to a product of the input value and the weight are assigned to each node of the fully-connected layer 56, in a similar manner to a normal neural network. Each of the pixel values of the images in the pooling layer 55, the pixel values being input to each of the nodes of the fully-connected layer 56, is transformed with a weight and bias thereof, and then added as an output value of each of the nodes.

In an output layer 57, output values of the 10 nodes of the fully-connected layer 56 are transformed into output values of 10 nodes of the output layer 57 by a softmax function. The softmax function transforms the output values of the respective nodes of the fully-connected layer 56 into values representing probabilities that apply to a class corresponding to respective nodes of the output layer 57.

Training of the learning model (CNN) will be described.

A data set (training data) including training images (input data) with a large number of ground truth labels (ground truth outputs) is used for learning of a parameter included in the CNN, such as a weight of a convolution filter in the CNN, or a weight or a bias in the fully-connected layer 56 in the CNN. In a case where Y is an output of the CNN when a training image (input data) of the training data is input to the CNN, and where Y_{gt} is a ground truth output of the training image, a parameter W included in the CNN is updated to satisfy the following Formula (1).

W=argmin_{W}{E(Y,Y_{gt})+λ·R(W)} (1)

In Formula (1), a function argmin_{W} represents a value of the parameter W when a value of the formula in parentheses is a minimum value. A first term E(Y, Y_{gt}) of a mathematical formula in the argument argmin_{W} is an error term (difference between output Y and ground truth output Y_{gt}), and the second term λ·R(W) represents a regularization term.

The function E(Y, Y_{gt}) in the error term represents a loss function representing a degree of difference between the output Y and ground truth output Y_{gt} of the CNN. As the loss function, a well-known function that derives a sum of squared error, a cross-entropy loss, or the like can be used.

In general, a regularization term is added to an error term to prevent overtraining so that a parameter W does not become too large, and thus to achieve stabilized training and accuracy improvement. Well-known regularizations are L1 regularization using, as a regularization term, a function R(W) for calculating a sum of absolute values of the parameter W, and L2 regularization using, as a regularization term, the function R(W) for calculating a square sum of the parameter W. Note that A in the regularization term is an adjustment value predetermined by user designation or the like.

In training of a CNN, the parameter W is calculated such that a sum of the error term and the regularization term becomes a minimum value.

In training of the CNN in the present embodiment, R(W) in the regularization term is expressed by the following Formulas (2) to (4) on the basis of the L1 regularization.

R(W)=R₁(W₁)+ΣₘR₂(Wₘ)(m is an integer of 2 or more) (2)

where W₁ represents parameters (weights) of all the convolution filters for the first layer in the CNN. Wₘ represents a parameter (weight) of an m-th convolution filter (m is an integer of 2 or more) included in the CNN. The second term on the right-hand side of Formula (2) represents a value obtained by summing R₂(Wₘ) for a parameter Wₘ of the m-th convolution filter, for all the layers other than the first convolution layer included in the CNN.

R₁(W₁) and R₂(Wₘ) are expressed by the following Formulas (3) and (4), respectively.

R₁(W₁)=Σ_{n,x,y,c}|wₙ(x,y,c)|+α·Σ_{n,c}|Σ_{x,y}wₙ(x,y,c)| (3)

R₂(Wₘ)=Σ_{n,x,y,c}|wₙ(x,y,c)| (4)

Here, in Formula (3), n represents a number uniquely assigned to all the convolution filters for the first layer. x and y represent positions in a horizontal direction and a vertical direction (x coordinate and y coordinate) in the convolution filter. c represents a position (channel number) in a depth direction in the convolution filter. wₙ (x, y, c) represents a parameter (coefficient, that is, a weight) of a position (x, y, c) in the n-th convolution filter. α represents an adjustment value predetermined by user designation or the like.

The first term on the right-hand side of Formula (3) represents a total sum of absolute values of all weights of all the convolution filters for the first layer. The second term on the right-hand side of Formula (3) represents a value obtained by summing absolute values of total sums of weights of all the positions (x coordinate and y coordinate) in each channel of each convolution filter in the first layer, for all the channels of all the convolution filters for the first layer.

In Formula (4), n represents a number assigned to convolution filters for an m-th layer (m is an integer of 2 or more). Other variables x, y, and c are the same as in Formula (3). The first term on the right-hand side of Formula (4) represents a total sum of absolute values of all weights of convolution filters for the m-th layer.

Note that R(W) in the regularization term may be interpreted as a total sum of a sum of the absolute values of all the weights of all the convolution filters for the first layer and the second and subsequent layers, and the second term on the right-hand side of Formula (3).

According to R(W) in the regularization term expressed by Formulas (2) to (4), the first term on the right-hand side of Formula (3) and the first term on the right-hand side of Formula (4) are well-known L1 regularization terms. Training is performed such that the weight of each of the convolution filters does not become too large due to the L1 regularization term.

The second term on the right-hand side of Formula (3) is a regularization term for making a first-term convolution filter zero-sum (hereinafter, referred to as a zero-sum regularization term). Weights are learned such that a total sum of the weights for the respective channels of the respective convolution filters for the first layer approaches 0 (becomes 0), that is, so as to become a zero-sum convolution filter.

R(W) in the regularization term in Formula (1) is, but not limited to, a value obtained by adding a zero-sum regularization term to an L1 regularization term on the basis of L1 regularization. R(W) in the regularization term may be a value obtained by adding a zero-sum regularization term to an L2 regularization term on the basis of L2 regularization.

Based on the L2 regularization, R₁(W₁) and R₂(Wₘ) in Formula (2) representing R(W) in the regularization term are expressed by the following Formulas (5) and (6), respectively.

R₁(W₁)=Σ_{n,x,y,c}{wₙ(x,y,c)}²+π·Σ_{n,c}|Σ_{x,y}wₙ(x,y,c)| (5)

R₂(Wₘ)=Σ_{n,x,y,c}{wₙ(x,y,c)}² (6)

where n, x, y, c, and α in Formula (5) are the same as in a case of Formula (3). n, x, y, and c in Formula (6) are the same as in a case of Formula (4).

The first term on the right-hand side of Formula (5) represents a total sum of values obtained by squaring all the weights of all the convolution filters for the first layer. The second term on the right-hand side of Formula (5) is a zero-sum regularization term same as the second term on the right-hand side of Formula (3).

The first term on the right-hand side of Formula (6) represents a total sum of values obtained by squaring all the weights of convolution filters for an m-th layer.

The zero-sum regularization term as the second term on the right-hand side of Formula (3) or (5) is a value (L1 norm) obtained by summing absolute values of total sums of all the weights in each channel of each convolution filter in the first layer, for all the channels of all the convolution filters for the first layer, but the zero-sum regularization term may be an L2 norm. In a case where the zero-sum regularization term is an L2 norm, the zero-sum regularization term as the second term on the right-hand side of Formula (3) or Formula (5) is changed to the following Formula (7).

Zero-sum regularization term=α·Σ_{n,c}{Σ_{x,y}wₙ(x,y,c)}² (7)

where n, x, y, c, and α in Formula (7) are the same as in a case of Formula (3).

The zero-sum regularization term as Formula (7) is a value (L2 norm) obtained by summing values obtained by squaring total sums of all the weights in each channel of each convolution filter in the first layer, for all the channels of all the convolution filters for the first layer.

In a case where an L2-norm zero-sum regularization term is used, as compared with a case where an L1-norm zero-sum regularization term is used, a gradient of the zero-sum regularization term becomes gentle when a total sum of all the weights in each channel of each convolution filter in the first layer approaches 0 (when the zero-sum regularization term approaches 0). Conversely, a gradient of the zero-sum regularization term becomes steep when the total sum of all the weights in each channel of each convolution filter in the first layer deviates from 0 (when the zero-sum regularization term deviates from 0). Therefore, an effect of regularization can be weakened at a position near 0 of the zero-sum regularization term, and the effect of regularization can be strengthened at a position away from the 0 of the zero-sum regularization term. For a purpose of stabilized training, adjustment for regularization near 0 of the zero-sum regularization term, or the like, the zero-sum regularization term may be selectively used for the L1 norm or the L2 norm.

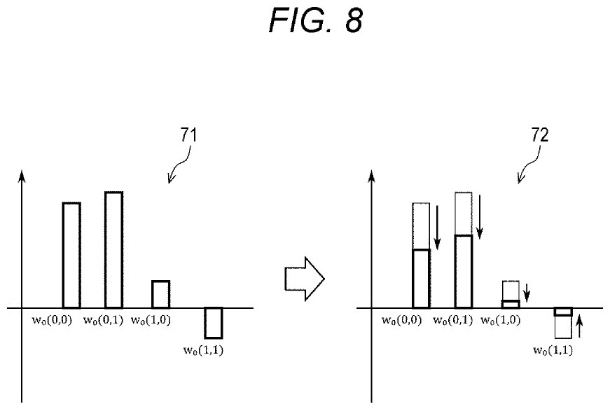

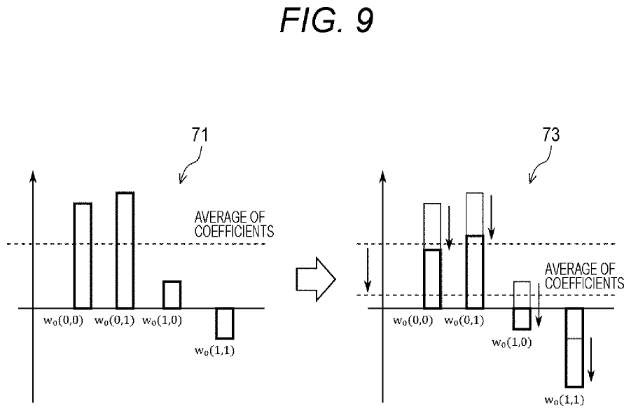

FIGS. 8 and 9 are diagrams describing action of a regularization term.

In FIGS. 8 and 9, attention is paid to weights of predetermined channels of a convolution filter for the first layer. The number 0 is assigned to the convolution filter. It is assumed that the filter size (W×H) of the channel of interest is 2×2. Weights wₙ (x, y, c) of interest are represented by w₀ (0, 0), w₀ (0, 1), w₀ (1, 0), and w₀ (1, 1) when the channel number is omitted.

Graph 71 in FIG. 8 illustrates, as a bar chart, values of the respective weights w₀ (0, 0), w₀ (0, 1), w₀ (1, 0), and w₀ (1, 1) in a case where learning is performed without adding a regularization term λ·R(W) to the error term in Formula (1).

Graph 72 in FIG. 8 illustrates, as a bar chart, values of the respective weights w₀ (0, 0), w₀ (0, 1), w₀ (1, 0), and w₀ (1, 1) of when learning is performed without including the second term on the right-hand side (zero-sum regularization term) of Formula (3) in R(W) in the regularization term expressed by Formulas (2) to (4), in a case where the regularization term λ·R(W) is added to the error term as in Formula (1).

In comparison between Graph 71 and Graph 72, absolute values of the weights w₀ (0, 0), w₀ (0, 1), w₀ (1, 0), and w₀ (1, 1) are reduced in a direction of decrease by including the regularization term λ·R(W) in the error term as in Formula (1). In this regard, however, because both positive and negative values of the weights w₀ (0, 0), w₀ (0, 1), w₀ (1, 0), and w₀ (1, 1) approach 0, a direct effect of bringing a sum of the weights w₀ (0, 0), w₀ (0, 1), w₀ (1, 0), and w₀ (1, 1) close to 0 is small. In a case where A of the regularization term λ·R(W) is set to a large value to enhance an effect of regularization, the sum can be brought close to 0, but all the weights are brought close to 0. In that case, because information of a feature amount is merely lost from the target image by the convolution operation, A cannot be set to such a large value in order to bring the sum close to 0.

Graph 71 in FIG. 9 illustrates, as a bar chart, values of the respective weights w₀ (0, 0), w₀ (0, 1), w₀ (1, 0), and w₀ (1, 1) in a case where learning is performed under the same conditions as Graph 71 in FIG. 8. Here, FIG. 9 illustrates average values of the weights w₀ (0, 0), w₀ (0, 1), w₀ (1, 0), and w₀ (1, 1).

Graph 73 in FIG. 9 illustrates, as a bar chart, values of the respective weights w₀ (0, 0), w₀ (0, 1), w₀ (1, 0), and w₀ (1, 1) of when learning is performed by using R(W) in the regularization term (including zero-sum regularization term) as expressed by Formulas (2) to (4), in a case where the regularization term λ·R(W) is added to the error term as in Formula (1).

In comparison between Graph 71 and Graph 73, the weights w₀ (0, 0), w₀ (0, 1), w₀ (1, 0), and w₀ (1, 1) are adjusted so that a sum (average value) thereof approaches zero by including the regularization term λ·R(W) in the error term as in Formula (1), and by including the second term on the right-hand side (zero-sum regularization term) of Formula (3) in R(W). That is, in a case where an average of the weights is a positive value as in Graph 71, the weights w₀ (0, 0), w₀ (0, 1), w₀ (1, 0), and w₀ (1, 1) as in Graph 73 are shifted to negative values as a whole.

In this manner, by using Formulas (2) to (4) as R(W) in the regularization term, learning is performed such that each convolution filter for the first layer becomes a zero-sum convolution filter for each channel.

(Procedure for Learning Processing of CNN)

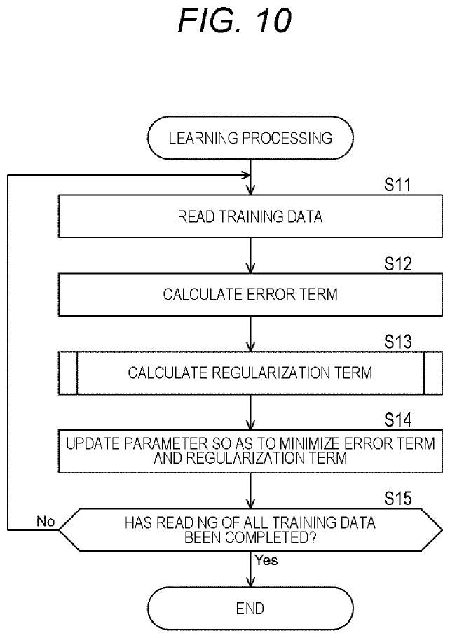

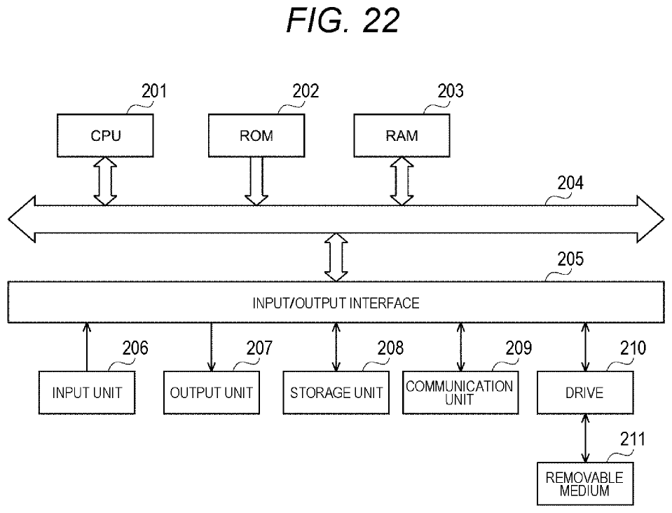

FIG. 10 is a flowchart exemplifying a procedure for learning processing of a learning model (CNN) executed by the recognizer 32 in FIG. 1. Note that the recognizer 32 performs the learning processing of the CNN. In this regard, however, an arbitrary apparatus (such as a computer illustrated in FIG. 22 to be described later) different from the recognizer 32 may perform the learning processing of the CNN. In a case where an apparatus different from the recognizer 32 performs the learning processing, data such as CNN parameters set by the learning processing is supplied to the recognizer 32.

In Step S11 in FIG. 10, the recognizer 32 reads training data. The processing proceeds from Step S11 to Step S12.

In Step S12, the recognizer 32 inputs the target image (input data) of the training data read in Step S11 to the CNN, and calculates an output of the CNN. Note that initial values of various parameters of the CNN are set, by learning, to random values, for example. The recognizer 32 calculates the error term in the above Formula (1) on the basis of the calculated output Y of the CNN and the ground truth output Y_{gt} for the input target image. The processing proceeds from Step S12 to Step S13.

In Step S13, the recognizer 32 calculates the regularization term λ·R(W) of the above Formula (1) on the basis of the currently set parameter W. R(W) in the regularization term is calculated on the basis of the above Formulas (2) to (4). An adjustment value A is set to a predetermined value or a value designated by the user. The processing proceeds from Step S13 to Step S14.

In Step S14, the recognizer 32 updates the parameter W of the CNN so as to minimize the sum of the error term calculated in Step S12 and the regularization term calculated in Step S13. The processing proceeds from Step S14 to Step S15.

In Step S15, the recognizer 32 determines whether or not reading of all the training data has been completed. Note that there are, for example, a few tens of thousands of pieces of training data, and the processing in Steps S11 to S15 is repeated by the number of pieces of training data.

In a case where it is determined in Step S15 that the reading of all the training data has been completed, the processing returns to Step S11 and is repeated from Step S11.

In a case where it is determined in Step S15 that the reading of all the training data has not been completed, the processing ends.

Note that the recognizer 32 may repeat the processing in this flowchart a predetermined number of times by using the same training data (data set).

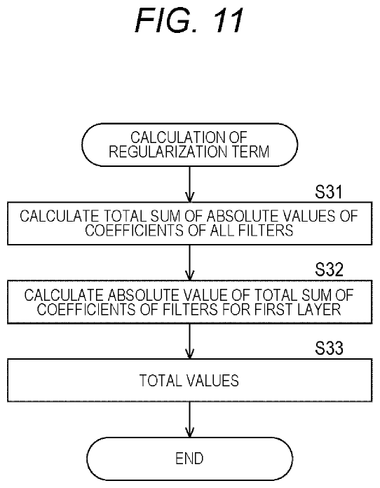

FIG. 11 is a flowchart exemplifying calculation processing of the regularization term in Step S13 in FIG. 10.

In Step S31, the recognizer 32 calculates the total sum of the absolute values of coefficients (weights) of all the convolution filters of the CNN. The calculated total sum corresponds to a sum of a value of the first term on the right-hand side of Formula (3) and the first term on the right-hand side of Formula (4). The processing proceeds from Step S31 to Step S32.

In Step S32, the recognizer 32 calculates an absolute value of a total sum (total sum for each channel) of the coefficients (weights) of the convolution filters for all the channels of all the convolution filters for the first layer. A value obtained by summing these calculated absolute values corresponds to the second term on the right-hand side of Formula (4). The processing proceeds from Step S32 to Step S33.

In Step S33, the recognizer 32 adds the sum calculated in Step S31 and the absolute value calculated in Step S32. With this arrangement, R(W) in the regularization term is calculated, and the regularization term λ·R(W) is calculated by multiplying R(W) by a predetermined adjustment value A.

In the learning processing of the CNN in FIGS. 10 and 11 described above, the coefficients (weights) of the convolution filters are updated for each of the training data, but the present technology is not limited thereto. For example, the error term E(Y, Y_{gt}) in Formula (1) may be a sum (or an average value) of error terms (Y, Y_{gt}) for a plurality of training data, and the coefficients of the convolution filters may be updated for each of the plurality of training data.

In the above-described learning processing of the CNN, the coefficients (weights) in the zero-sum convolution filter are learned with the second term on the right-hand side of Formula (3) or of Formula (5), or the zero-sum regularization term in Formula (7), but the present technology is not limited thereto.

As another example 1, in the learning processing of the CNN, each time a weight of a convolution filter (parameter of the CNN) is updated, each weight may be forcibly updated so that a total sum of the weights of the zero-sum convolution filters in each channel becomes 0.

As another example 2, in the learning processing of the CNN, each time a weight of a convolution filter (parameter of the CNN) is updated, an average of weights of the respective channels of the zero-sum convolution filters may be subtracted from each weight to make the total sum of the weights in the respective channels become 0.

The convolution filters may be updated by using the regularization term λ·R(W) including the zero-sum regularization term, and another example 1 or 2 may be performed together.

(Procedure for Image Recognition Processing by Image Recognition Apparatus 11)

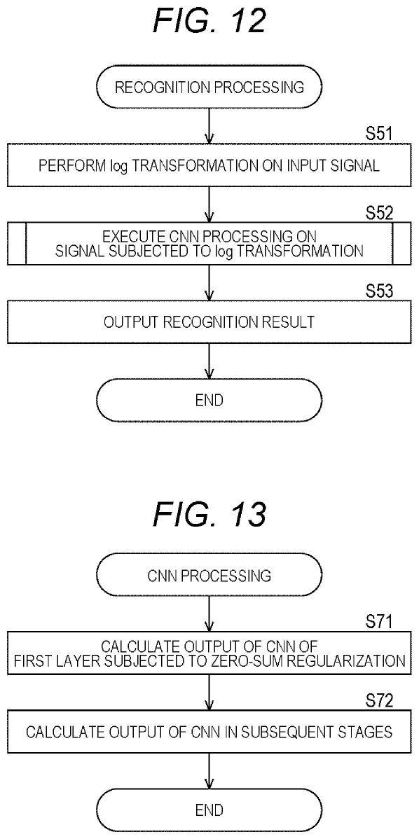

FIG. 12 is a flowchart exemplifying a processing procedure for image recognition processing performed by the image recognition apparatus 11.

In Step S51, the pre-processing unit 31 performs log transformation on the input target image (input data). The processing proceeds from Step S51 to Step S52.

In Step S52, the recognizer 32 performs CNN processing on the target image subjected to the log transformation in Step S51. The processing proceeds from Step S52 to Step S53.

In Step S53, the recognizer 32 outputs a result of the recognition with the CNN processing in Step S52.

The processing in Steps S51 to S53 described above is executed every time a target image is input to the image recognition apparatus 11.

FIG. 13 is a flowchart exemplifying a processing procedure for CNN processing in Step S52 in FIG. 12.

In Step S71, the recognizer 32 (first CNN processing unit 41) performs a convolution operation on the target image from the pre-processing unit 31 by using a zero-sum convolution filter for a first layer of the CNN (convolution filter for which a weight is set by zero-sum regularization), and calculates an output of the CNN of the first layer. The processing proceeds from Step S71 to Step S72.

In Step S72, the recognizer 32 (second CNN processing unit 42) calculates an output of the CNN in a stage subsequent to the first layer with respect to the CNN output calculated in Step S71.

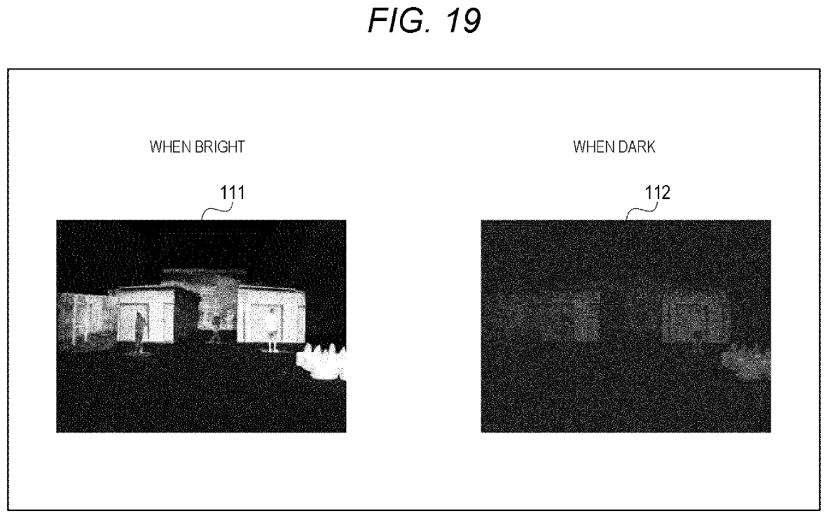

According to the image recognition apparatus 11 described above, in the CNN of the learning model used for image recognition, by using the zero-sum convolution filters as the first-layer convolution filters, even in a case where brightness is different, image recognition is performed with equivalent recognition accuracy for target images of the same subject. That is, it is possible to perform image recognition with reduced influence of brightness in a target image. Note that what kind of image is actually generated by a zero-sum convolution filter will be exemplified in FIGS. 19 to 21.

According to the image recognition apparatus 11, it is not necessary to correct a signal level of a target image from an image sensor, the target image including pixels having different spectral characteristics. In general, outputs of pixels using different filters have different signal levels. As a specific example, a G pixel has higher sensitivity and higher signal level than R and B pixels. Therefore, a gain is corrected to correct a signal level for outputs of pixels having different filters.

Meanwhile, in the image recognition apparatus 11, influence of a gain is removed, and therefore the signal level does not need to be corrected.

It is possible to perform image recognition with high accuracy without performing signal level correction on an image from an image sensor, to which clear pixels, such as RGBW, having a large signal level are added.

According to the image recognition apparatus 11, even in a case where a spectral characteristic approaches flat due to aging due to aging, influence thereof is reduced by the zero-sum convolution filter for the first layer.

(Modification 1 of Recognizer 32)

Although all of the convolution filters for the first layer are zero-sum convolution filters in the recognizer 32 in FIG. 1, at least one or more of the convolution filters for the first layer may be zero-sum convolution filters. In a case where one convolution filter includes a plurality of channels (three channels in the example in FIG. 7), a part of the plurality of channels (at least one or more channels) may be a zero-sum convolution filter. In this case, in training of the CNN used by the recognizer 32, a value related to a weight as a non-zero-sum convolution filter, not zero-sum, is excluded in the zero-sum regularization term as the second term on the right-hand side of Formula (3) or (5), or the zero-sum regularization term in Formula (7). In a case where the learning model is a neural network including only one convolution layer and having a plurality of convolution filters, at least one or more of the plurality of convolution filters may be zero-sum convolution filters.

In a case where a part of the convolution filters for the first layer is a non-zero-sum convolution filter, a DC component included in the target image is sent to a subsequent stage without being completely lost. In a case where it is better to use a signal level itself of the DC component for recognition, image recognition accuracy may be improved by using a non-zero-sum convolution filter as a part of the convolution filters for the first layer.

For example, by inputting a temperature image from an infrared camera as a target image of the image recognition apparatus 11 to the image recognition apparatus 11, it is possible to detect a human from a spatial change in temperature. In this case, temperature is directly detected by using not only a zero-sum convolution filter but also a non-zero-sum convolution filter for the first layer of the CNN used in the recognizer 32. By detecting a temperature, even if a silhouette of a non-human object has a human shape, if the temperature thereof is not in a range of human temperature (about 20 to 40 degrees), it is possible to avoid erroneous recognition in which the object is recognized as a human. By transmitting the DC component of the target image to the subsequent stages by using a non-zero-sum convolution filter for a part of the convolution filters for the first layer, it is possible to cause the CNN to learn such image recognition.

(Modification 2 of Recognizer 32)

Although only the convolution filters for the first layer are zero-sum convolution filters in the recognizer 32 in FIG. 1, a part of the convolution filters for the second layer may be a zero-sum convolution filter. That is, a zero-sum convolution filter may be used in one or more channels of one or more convolution filters for the second layer. By adding a zero-sum convolution filter to the second layer in this manner, influence of noise is reduced.

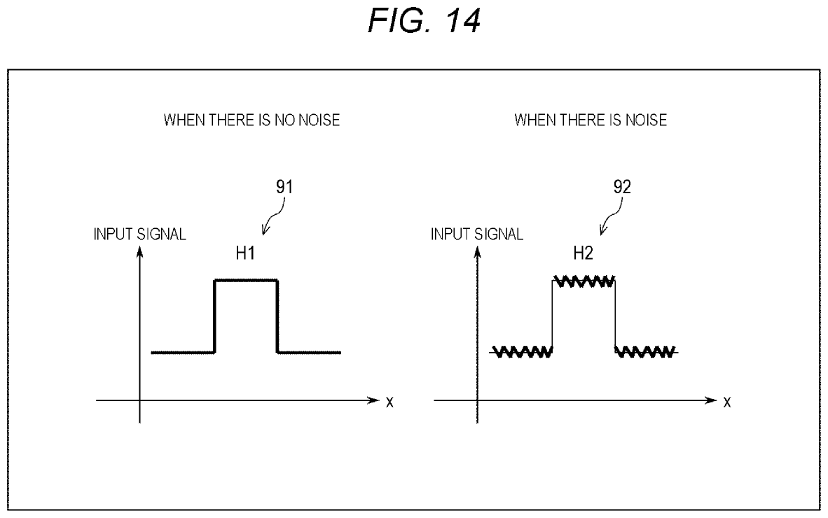

FIGS. 14 to 17 are diagrams describing action of the CNN in a case where there is a zero-sum convolution filter in the second layer.

In Graphs 91, 92 in FIG. 14, image signals H1, H2 represent image signals of the target image input to the recognizer 32. The image signal H1 in Graph 91 represents a case where there is no noise, and the image signal H2 in Graph 92 represents a case where there is noise in the image signal H1.

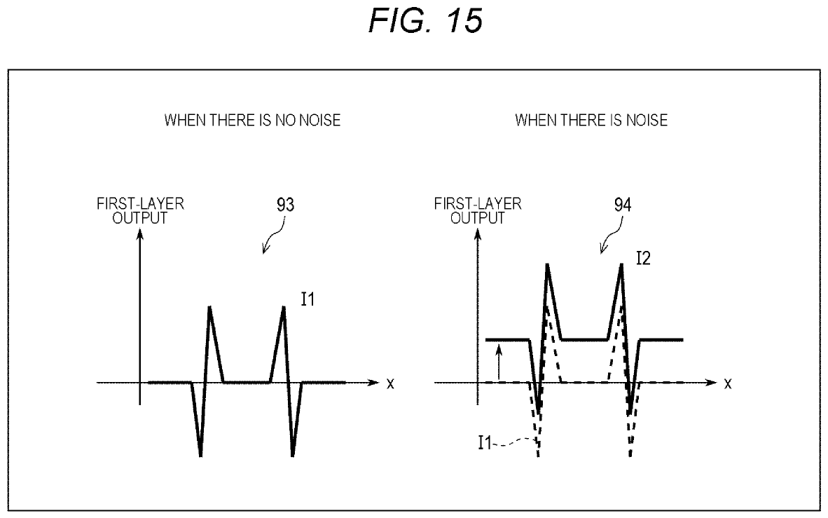

In Graphs 93, 94 in FIG. 15, image signals I1, I2 represent response signals (first-layer output) in a case where a convolution operation is performed on the image signals H1, H2, respectively by using the zero-sum convolution filter (−1, 2, −1). According to this, in the image signal H2, an offset occurs to the image signal H1 due to influence of noise.

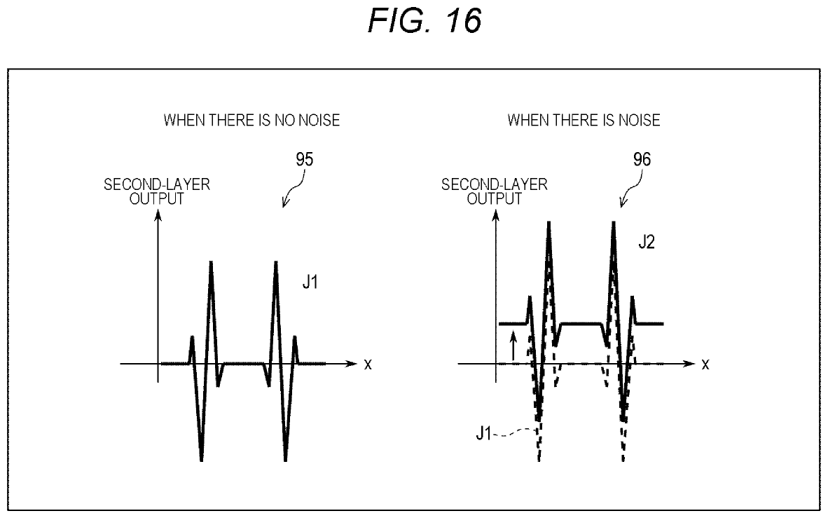

In Graphs 95, 96 in FIG. 16, image signals J1, J2 represent response signals (second-layer output) in a case where a convolution operation is performed on the image signals I1, I2, respectively by using the non-zero-sum convolution filter (−1, 3, −1). According to this, an offset that has occurred in the image signal I2 due to influence of noise remains in the image signal J2, and an offset occurs in the image signal J1.

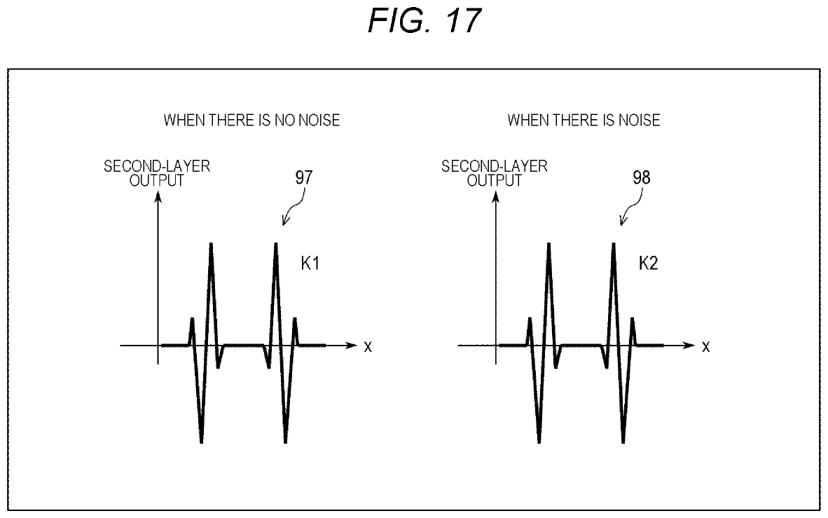

In Graphs 97, 98 in FIG. 17, image signals K1, K2 represent response signals (second-layer output) in a case where a convolution operation is performed on the image signals I1, I2, respectively by using the zero-sum convolution filter (−1, 2, −1). According to this, in the image signal K2, influence of an offset that has occurred in the image signal I2 due to influence of noise is reduced, and the image signal K2 becomes a signal substantially similar to the image signal K1. Therefore, influence of noise included in the target image is reduced by using a zero-sum convolution filter for a second layer. In a case where there are three or more convolution filters in the CNN, a zero-sum convolution filter may be used in one or more channels of one or more convolution filters among the convolution filters for the second and subsequent layers. In the training of the CNN used by the recognizer 32, also for channels of the zero-sum convolution filters for the second and subsequent layers, a zero-sum regularization term similar to the zero-sum regularization term as the second term on the right-hand side of Formula (3) or (5), or the zero-sum regularization term in Formula (7) is included in R(W) in the regularization term. There is a conceivable case where, in a case where the learning model includes a plurality of convolution filters, a zero-sum convolution filter may be adopted for one or more channels of any one or more convolution filters.

(Another Configuration Example of Image Recognition Apparatus 11)

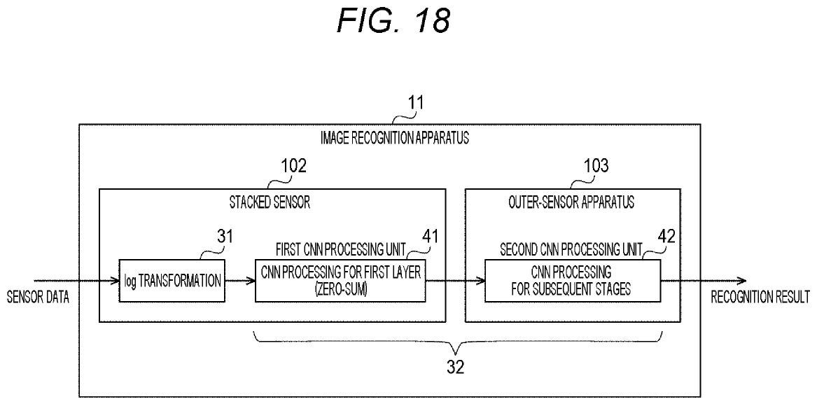

FIG. 18 is a block diagram illustrating another configuration example of the image recognition apparatus 11. Note that, in the drawing, the parts corresponding to the parts in the image recognition apparatus 11 in FIG. 1 are provided with the same reference signs, and description of the corresponding parts will be omitted.

In the image recognition apparatus 11 in FIG. 18, the pre-processing unit 31 in the image recognition apparatus 11 in FIG. 1 and the first CNN processing unit 41 of the recognizer 32 in FIG. 1 are incorporated into a stacked sensor 102. The stacked sensor 102 is a sensor in which a signal processing circuit is stacked on an image sensor such as a CMOS sensor. The second CNN processing unit 42 of the recognizer 32 in FIG. 1 is incorporated in an outer-sensor apparatus 103 that is outside the stacked sensor 102. Therefore, the first CNN processing unit 41 and the second CNN processing unit 42 that constitute the recognizer 32 are arranged separately in the stacked sensor 102 and the outer-sensor apparatus 10, respectively.

An image captured by the image sensor of the stacked sensor 102 is supplied, as a target image, to the pre-processing unit 31 in the stacked sensor 102. The target image supplied to the pre-processing unit 31 is subjected to log transformation in the pre-processing unit 31, and then supplied to the first CNN processing unit 41.

The target image supplied to the first CNN processing unit 41 is subjected to a convolution operation by a zero-sum convolution filter for a first layer in the first CNN processing unit 41. An image (feature map) generated as a result is transmitted to the second CNN processing unit 42 of the outer-sensor apparatus 103. In the second CNN processing unit 42, CNN processing subsequent to the first CNN processing unit 41 is executed on the basis of the image from the first CNN processing unit 41.

In this regard, however, a sensor into which the pre-processing unit 31 and the first CNN processing unit 41 are incorporated may not be the stacked sensor 102, and may be an image sensor or may be a case incorporated in the same chip as the image sensor.

According to the configuration of the image recognition apparatus 11 in FIG. 18, the DC component of the target image is cut by a zero-sum convolution filter, and therefore, there is a case where unnecessary bit assignment is not performed in the image sensor and a bit length is reduced. In particular, in a case where the image sensor that captures the target image is a high dynamic range (HDR) sensor, a sensor output having a high bit length is compressed, and therefore, bandwidth reduction and power saving are achieved.

(Actual Measurement Results of Convolution Operation by Zero-Sum Convolution Filter)

FIGS. 19 to 21 are diagrams describing results of convolution operations performed by the first CNN processing unit 41 in the recognizer 32 in FIGS. 1 and 19 by using a zero-sum convolution filter.

Target images 111 and 112 in FIG. 19 are a bright image of a subject (scene) shot in a bright shooting environment and a dark image of the subject shot in a dark shooting environment, respectively.

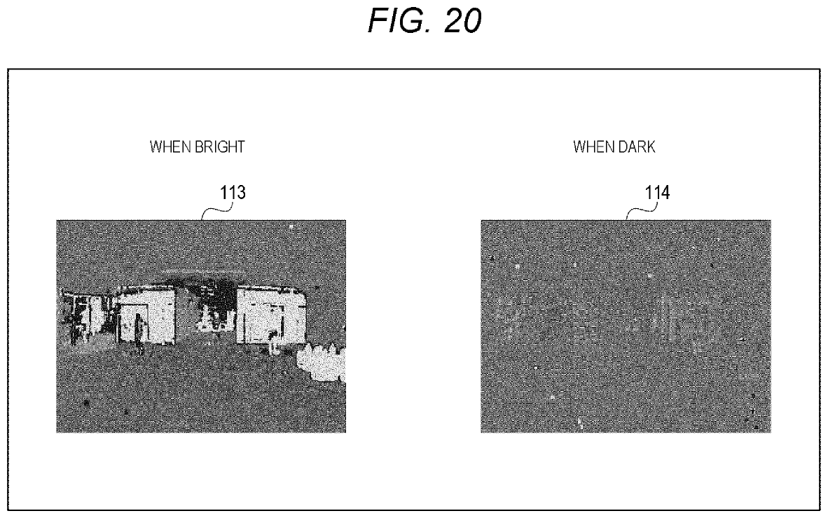

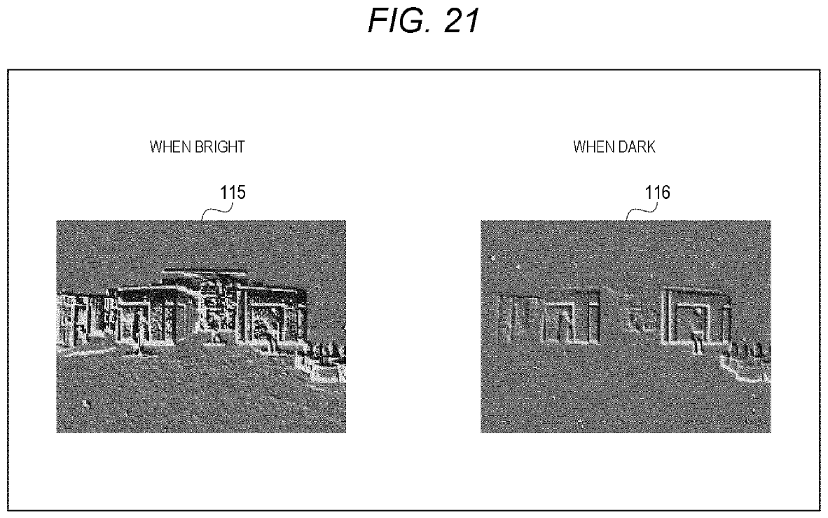

Images 113 and 114 in FIG. 20 represent images obtained by performing a convolution operation on the target images 111 and 112 in FIG. 19, respectively, by using a non-zero-sum convolution filter. In the image 114 obtained from the dark target image 112, information of the subject is substantially lost.

Images 115 and 116 in FIG. 21 represent images obtained by performing a convolution operation on the target images 111 and 112 in FIG. 19, respectively, by using a zero-sum convolution filter. In the image 116 obtained from the dark target image 112, similarly to the image 115 obtained from the bright target image 111, information such as an outline of the subject is extracted. With this arrangement, in the recognizer 32, appropriate image recognition is performed without image recognition accuracy being affected by brightness in the target image.

<Program>

Part or all of a series of processing in the pre-processing unit 31 and the recognizer 32 as described above and part or all of a series of processing of the learning processing of the learning model executed by the recognizer 32 as described above can be executed by hardware or can be executed by software. In a case where a series of processing is executed by software, a program included in the software is installed on a computer. Here, the computer includes, a computer incorporated in dedicated hardware, a general-purpose personal computer for example, which is capable of executing various kinds of functions by installing various programs, or the like.

FIG. 22 is a block diagram illustrating a configuration example of hardware of a computer that executes the above-described series of processing with a program.

In the computer, a central processing unit (CPU) 201, a read only memory (ROM) 202, and a random access memory (RAM) 203 are mutually connected by a bus 204.

Moreover, an input/output interface 205 is connected to the bus 204. An input unit 206, an output unit 207, a storage unit 208, a communication unit 209, and a drive 210 are connected to the input/output interface 205.

The input unit 206 includes a keyboard, a mouse, a microphone, or the like. The output unit 207 includes a display, a speaker, or the like. The storage unit 208 includes a hard disk, a non-volatile memory, or the like. The communication unit 209 includes a network interface, or the like. The drive 210 drives a removable medium 211 such as a magnetic disk, an optical disk, a magneto-optical disk, or a semiconductor memory.

In a computer configured as above, the series of processing described above is performed by the CPU 201 loading, for example, a program stored in the storage unit 208 to the RAM 203 via the input/output interface 205 and the bus 204 and executing the program.

A program executed by the computer (CPU 201) can be provided by being recorded on the removable medium 211 as a package medium, or the like, for example. Furthermore, the program can be provided via a wired or wireless transmission medium such as a local area network, the Internet, or digital satellite broadcasting.

In the computer, the program can be installed on the storage unit 208 via the input/output interface 205 by attaching the removable medium 211 to the drive 210. Furthermore, the program can be received by the communication unit 209 via the wired or wireless transmission medium and installed on the storage unit 208. In addition, the program can be installed on the ROM 202 or the storage unit 208 in advance.

Note that, the program executed by the computer may be a program that is processed in time series in an order described in this specification, or a program that is processed in parallel or at a necessary timing such as when a call is made.

Note that the present technology can have the following configurations.

(1) A method for generating a learning model, the method including

training the learning model such that a total sum of coefficients in one or more channels of at least one or more convolution filters among the convolution filters for a first layer of a neural network including a plurality of the convolution filters approaches zero, the neural network being applied to the learning model that performs recognition processing on input data.

(2) The method for generating a learning model according to (1), the method including

training the learning model such a total sum of the coefficients approaches zero for each of all the channels of at least one or more the convolution filters among the convolution filters for the first layer.

(3) The method for generating a learning model according to (1) or (2), the method including

training the learning model such that a sum of an error term based on a difference between an output of the learning model when input data with a ground truth output is input to the learning model and the ground truth output, and a regularization term based on the coefficients of the convolution filters included in the neural network is minimized.

(4) The method for generating a learning model according to any one of (1) to (3),

in which the regularization term includes a value corresponding to an absolute value of a total sum of the coefficients in the channels of the convolution filters for which the total sum of the coefficients is brought close to zero.

(5) The method for generating a learning model according to any one of (1) to (3),

in which the regularization term includes a value proportional to a value obtained by squaring a total sum of the coefficients in the channels of the convolution filters for which the total sum of the coefficients is brought close to zero.

(6) The method for generating a learning model according to any one of (3) to (5),

in which the regularization term includes a value corresponding to a total sum of absolute values of all the coefficients in all the convolution filters included in the neural network.

(7) The method for generating a learning model according to any one of (3) to (5),

in which the regularization term includes a value corresponding to a total sum of values obtained by squaring all the coefficients in all the convolution filters included in the neural network.

(8) The method for generating a learning model according to any one of (1) to (7), the method including

training the learning model such that a total sum of coefficients in one or more of the channels of at least one or more the convolution filters among the convolution filters for a second layer of the neural network approaches zero.

(9) The method for generating a learning model according to any one of (3) to (8), the method including,

when the coefficients in the channels of the convolution filters for which the total sum of the coefficients is brought close to zero by the minimization are updated, zeroing a total sum of the coefficients in the channels of the convolution filters for which the total sum of the coefficients is brought close to zero.

(10) The method for generating a learning model according to any one of (3) to (9), the method including,

when the coefficients in the channels of the convolution filters for which the total sum of the coefficients is brought close to zero by the minimization are updated, subtracting, from the coefficients, an average of the coefficients in the channels of the convolution filters for which the total sum of the coefficients is brought close to zero.

(11) The method for generating a learning model according to any one of (1) to (10),

in which the input data is image data.

(12) A program for causing a computer to function as

a processing unit that trains a learning model such that a total sum of coefficients in one or more channels of at least one or more convolution filters among the convolution filters for a first layer of a neural network including a plurality of the convolution filters approaches zero, the neural network being applied to the learning model that performs recognition processing on input data.

(13) An information processing apparatus including

a processing unit that executes an operation of a learning model trained such that a total sum of coefficients in one or more channels of at least one or more convolution filters among the convolution filters for a first layer of a neural network including a plurality of the convolution filters approaches zero, the neural network being applied to the learning model that performs recognition processing on input data.

(14) The information processing apparatus according to (13), the apparatus including,

in a previous stage of the processing unit, a pre-processing unit that transforms the input data with a predetermined function.

(15) The information processing apparatus according to (14),

in which the pre-processing unit transforms the input data with a log function.

(16) The information processing apparatus according to (14),

in which the processing unit transforms the input data with a polyline function.

(17) The information processing apparatus according to (14),

in which the processing unit transforms the input data with a gamma curve.

(18) The information processing apparatus according to any one of (13) to (17),

in which the processing unit executes an operation of the learning model trained such that a total sum of coefficients in one or more of the channels of at least one or more the convolution filters among the convolution filters for a second layer of the neural network approaches zero.

### REFERENCE SIGNS LIST

11 Image recognition apparatus
31 Pre-processing unit
32 Recognizer
41 First CNN processing unit
42 Second CNN processing unit

1. A method for generating a learning model, the method comprising
training the learning model such that a total sum of coefficients in one or more channels of at least one or more convolution filters among the convolution filters for a first layer of a neural network including a plurality of the convolution filters approaches zero, the neural network being applied to the learning model that performs recognition processing on input data.

2. The method for generating a learning model according to claim 1, the method comprising
training the learning model such that a total sum of the coefficients approaches zero for each of all the channels of at least one or more the convolution filters among the convolution filters for the first layer.

3. The method for generating a learning model according to claim 1, the method comprising
training the learning model such that a sum of an error term based on a difference between an output of the learning model when input data with a ground truth output is input to the learning model and the ground truth output, and a regularization term based on the coefficients of the convolution filters included in the neural network is minimized.

4. The method for generating a learning model according to claim 3,
wherein the regularization term includes a value corresponding to an absolute value of a total sum of the coefficients in the channels of the convolution filters for which the total sum of the coefficients is brought close to zero.

5. The method for generating a learning model according to claim 3,
wherein the regularization term includes a value proportional to a value obtained by squaring a total sum of the coefficients in the channels of the convolution filters for which the total sum of the coefficients is brought close to zero.

6. The method for generating a learning model according to claim 3,
wherein the regularization term includes a value corresponding to a total sum of absolute values of all the coefficients in all the convolution filters included in the neural network.

7. The method for generating a learning model according to claim 3,
wherein the regularization term includes a value corresponding to a total sum of values obtained by squaring all the coefficients in all the convolution filters included in the neural network.

8. The method for generating a learning model according to claim 1, the method comprising
training the learning model such that a total sum of coefficients in one or more of the channels of at least one or more the convolution filters among the convolution filters for a second layer of the neural network approaches zero.

9. The method for generating a learning model according to claim 3, the method comprising,
when the coefficients in the channels of the convolution filters for which the total sum of the coefficients is brought close to zero by the minimization are updated, zeroing a total sum of the coefficients in the channels of the convolution filters for which the total sum of the coefficients is brought close to zero.

10. The method for generating a learning model according to claim 3, the method comprising,
when the coefficients in the channels of the convolution filters for which the total sum of the coefficients is brought close to zero by the minimization are updated, subtracting, from the coefficients, an average of the coefficients in the channels of the convolution filters for which the total sum of the coefficients is brought close to zero.

11. The method for generating a learning model according to claim 1,
wherein the input data is image data.

12. A program for causing a computer to function as
a processing unit that trains a learning model such that a total sum of coefficients in one or more channels of at least one or more convolution filters among the convolution filters for a first layer of a neural network including a plurality of the convolution filters approaches zero, the neural network being applied to the learning model that performs recognition processing on input data.

13. An information processing apparatus comprising
a processing unit that executes an operation of a learning model trained such that a total sum of coefficients in one or more channels of at least one or more convolution filters among the convolution filters for a first layer of a neural network including a plurality of the convolution filters approaches zero, the neural network being applied to the learning model that performs recognition processing on input data.

14. The information processing apparatus according to claim 13, the apparatus comprising,
in a previous stage of the processing unit, a pre-processing unit that transforms the input data with a predetermined function.

15. The information processing apparatus according to claim 14,
wherein the pre-processing unit transforms the input data with a log function.

16. The information processing apparatus according to claim 14,
wherein the processing unit transforms the input data with a polyline function.

17. The information processing apparatus according to claim 14,
wherein the processing unit transforms the input data with a gamma curve.

18. The information processing apparatus according to claim 13,
wherein the processing unit executes an operation of the learning model trained such that a total sum of coefficients in one or more of the channels of at least one or more the convolution filters among the convolution filters for a second layer of the neural network approaches zero.
